(19) United States
(12) Patent Application Publication
(10) Pub. No.: US 2013/0275214 A1
(43) Pub. Date: Oct. 17, 2013

(54) Vehicle Referral System and Service

(71) Applicant: AUTOMATIC LABS, INC., San Francisco, CA (US)

(72) Inventors: Thejovardhana S. Kote, San Francisco, CA (US); Jerald Jariyasunant, San Francisco, CA (US)

(73) Assignee: Automatic Labs, Inc., San Francisco, CA (US)

(21) Appl. No.: 13/860,819

(22) Filed: Apr. 11, 2013

Related U.S. Application Data
(60) Provisional application No. 61/623,738, filed on Apr. 13, 2012.
(60) Provisional application No. 61/623,770, filed on Apr. 13, 2012.

(51) Int. Cl. G06Q 30/02

(52) U.S. Cl. CPC G06Q 30/0255
USPC 705/14.53

(57) ABSTRACT

In one embodiment an apparatus includes at least one sensor for collecting data, the at least one sensor having connection to a first processor with a first memory, the first memory storing instructions that when executed by the processor cause the processor to record data associated with the act of driving a vehicle, upload the recorded data to a service control point having a second processor with a second memory, the second memory storing instructions that when executed by the processor cause the second processor to process the data received according to one or more pre-defined rules to develop a needs assessment relative to a new vehicle type, match the needs assessment to existing feature data and technical data profiles generic to one or more new vehicle types, and send at least one advertisement, notification, or promotional offer based on the match to the vehicle owner or owners.

### CROSS-REFERENCE TO RELATED DOCUMENTS

The present invention claims priority to U.S. provisional patent applications 61/623,738, filed Apr. 13, 2012, and 61/623,770, filed Apr. 13, 2012. Disclosure of the prior applications are incorporated herein in their entirety by reference.

### BACKGROUND OF THE INVENTION

1. Field of the Invention

The present invention is in the field of information management and pertains particularly to methods and apparatus for promoting or advertising a new vehicle based on data associated with the user and operational data associated with one or more current vehicles owned by the user.

2. Discussion of the State of the Art

In the art of sales, companies offering big-ticket items to consumers often do not have sufficient pre-qualifying information from sales prospects that might prove useful in determining which features and capabilities of the big-ticket item would most benefit those prospects should they purchase an item. One area where this is starkly evident is in vehicle sales.

Many people who purchase vehicles periodically fail to select the best type (make, model) of vehicle that would best serve the actual lifestyle they have and the conditions under which they have operated vehicles in the past. Many of these people have superficial or impulsive reasoning for purchasing a particular vehicle and may regret the purchase of the vehicle at a later date in time. This uncertainty may result in loss of client loyalty to a manufacturer or particular product line and ultimately loss of future sales from that client.

Therefore, what is clearly needed is a system for making an intelligent determination of what product type, capabilities, and features are best for a particular prospective buyer based on information gathered in the field relative to actual use of one or more similar products and lifestyle considerations.

### SUMMARY OF THE INVENTION

In one embodiment, an apparatus is provided, comprising at least one sensor for collecting data, the at least one sensor having connection to a first processor with a first memory, the first memory storing instructions that when executed by the processor cause the processor to record data associated with the act of driving a vehicle, upload the recorded data to a service control point having a second processor with a second memory, the second memory storing instructions that when executed by the processor cause the second processor to process the data received according to one or more pre-defined rules to develop a needs assessment relative to a new vehicle type, match the needs assessment to existing feature data and technical data profiles generic to one or more new vehicle types, and send at least one advertisement, notification, or promotional offer based on the match to the vehicle owner or owners.

In one embodiment, the recorded data includes mileage data, vehicle operation data, cargo weight data, trip length data, location data, climate data, and profile information. In one embodiment, at least one sensor is a wirelessly operated sensor. In one embodiment, the first processor is integrated with or has access to a vehicle engine control module (ECM) and a power train control module (PCM) through an onboard diagnostic port (OBD).

In one embodiment, the first processor is that of a hand-held computing appliance. In one embodiment, the location data is supplemented by global positioning satellite (GPS) via a local GPS device accessible to the first processor. In one embodiment, the service control point (SCP) is a server connected to an Internet network.

In one embodiment, the feature and technical data generic to new vehicle types are accessed from disparate servers hosted by disparate vehicle sales organizations competing for sales. In a variation of this embodiment, the at least one advertisement, notification, or promotional offer is sent from at least one of the vehicle sales organizations. In one embodiment, the feature data includes optional accessories.

According to one aspect of the invention a method is provided, comprising the acts recording data associated with the act of driving a vehicle, uploading the data to a service control point (SCP) for processing, developing a needs assessment from the uploaded data, matching the needs assessment to existing feature data and technical data profiles generic to one or more new vehicle types, and sending at least one advertisement, notification, or promotional offer based on the match to the vehicle owner or owners.

In one aspect of the method, the recorded data includes mileage data, vehicle operation data, cargo weight data, trip length data, location data, climate data, and profile information. In a variation of this aspect the location data is supplemented by global positioning satellite (GPS) data via a local GPS device. In one aspect the service control point (SCP) is a server connected to an Internet network. In one aspect the feature and technical data generic to new vehicle types are accessed from disparate servers hosted by disparate vehicle sales organizations competing for sales.

In one aspect the method further includes an act initiating an authorization for a discount or a rebate upon positive response to any of the at least one advertisement, notification, or promotional offer. In one aspect the feature and technical data generic to new vehicle types are accessed from disparate servers hosted by disparate vehicle sales organizations competing for sales. In one aspect the at least one advertisement, notification, or promotional offer is sent from at least one of the vehicle sales organizations. In one aspect the data is uploaded to the SCP periodically. In one aspect the feature data includes optional accessories.

### BRIEF DESCRIPTION OF THE DRAWING FIGURES

FIG. 1 is an architectural diagram of an information network supporting new vehicle recommendation according to an embodiment of the present invention.

FIG. 2 is a process flow chart depicting steps for generating a needs assessment from raw data and matching the assessment to one or more vehicle types.

FIG. 3 is a block diagram depicting basic server processing tasks implemented before a vehicle type recommendation is made.

### DETAILED DESCRIPTION

The inventors provide a system for assessing needs of a potential vehicle buyer and matching the assessment to one or more vehicle types recommended for purchase. The present invention is described in enabling detail using the following examples, which may describe more than one relevant embodiment falling within the scope of the present invention.

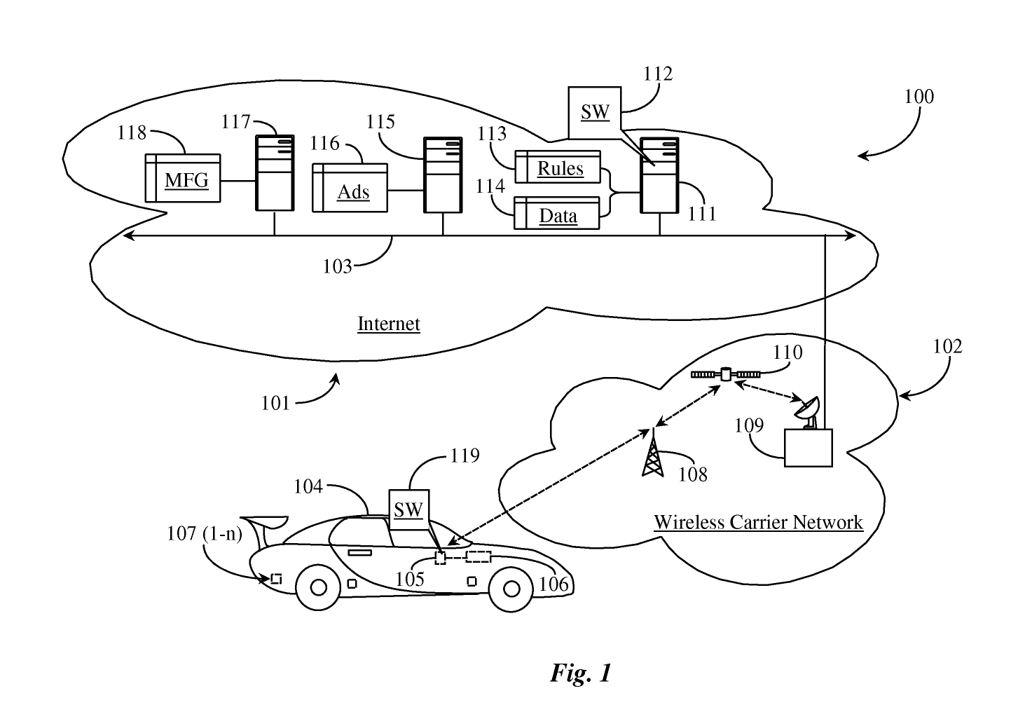

FIG. 1 is an architectural diagram of an information network 100 supporting new vehicle recommendation to potential vehicle buyers according to an embodiment of the present invention. Information network 100 includes an Internet network 101 and a wireless carrier network 102. Wireless carrier network 102 may be a digital cellular network, a satellite network, a wireless fidelity (WiFi) network, a WiMax network, a wireless local loop, or another types of wireless carrier without departing from the spirit and scope of the present invention.

Internet network 101 may be a corporate wide area network (WAN), a municipal area network (MAN) without departing from the spirit and the scope of the present invention. The inventor chooses the Internet network in this example because of a larger public access characteristic. Internet 101 is further exemplified by an Internet backbone 103. Internet backbone 103 represents all of the lines equipment and access points that make up the Internet as a whole including conn4ected sub-networks. Therefore, there are no geographical limitations in the practice of the present invention.

A vehicle 104 is represented in this embodiment as a client-operated vehicle that may be the subject of data collection, aggregation, and processing to generate a needs assessment for a new vehicle type for the operating client. Vehicle 104 may be any client-operated vehicle without departing from the spirit and scope of the present invention. In this embodiment, the vehicle is an automobile. In other embodiments, the vehicle may be a truck, a recreational vehicle, a service vehicle, and aerial vehicle such as a plane, or a boat. A consumer vehicle such as vehicle 104 represents a convenient example of a product relative to the invention.

Vehicle 104 includes an engine control module (ECU) 106. ECU 106 collects emission data from emissions components on the engine of vehicle 104 among other types of engine operational data and settings. ECU 106 may be integrated with a power train control module (PCM). ECU/PCM 106 provides various types of data from engine sensors and communicating electronics components in the engine, power train and transmission. The data may include vehicle handling and breaking data in different whether conditions. The data may include vehicle speed from an on board gauge or global positioning satellite data available to most ECU/PCM units. Other data types accessible though module 106 include but are not limited to torque, fuel to airflow ratio, exhaust data, inflow data, temperature data, revolutions per minute (RPM) data, fluid pressures, engine load (varying payloads), transmission load (varying payloads), braking data, emissions data, and various other customized data such as tire inflation data, tire alignment data, differential data, four wheel drive data, and so on.

ECU/PCM 106 is accessible from a mobile or android device through use of am on-board diagnostics (OBD) type connector. In this example, a mobile communications appliance 105 is illustrated and has connection to ECU/PCM 106 via an OBD connector. In one embodiment, a third-party intermediate device having wireless circuitry (not illustrated) is provided plugged into the OBD port on vehicle 104. Appliance 105 may be wirelessly paired to the intermediate device so access to data does not depend on a tether or cable. Typical use for an OBD accessible vehicle processor is to access data enabling diagnostic tests. A testing application running on a mobile computing appliance may receive real time data from ECU/PCM 106 for diagnostic evaluation of vehicle conditions. The vehicle constantly performs self-adjustments relative to electronic components in the vehicle for which data is collected while the vehicle running.

In a preferred embodiment of the invention, ECU/PCM 106 is accessed for the purpose of data mining to obtain data that might be aggregated and processed to determine what future needs might be discovered from the data for consideration of what type of new vehicle might best serve the operator of current vehicle 104 if the operator wanted or needed to purchase a new or used vehicle. Wireless communications appliance 105 collects raw data from ECU/PCM using a physical cable in this example, however wireless data collection is possible using Bluetooth™ paring with an intermediate device or with the ECU/PCM if enabled with a wireless communications device like Bluetooth™.

Wireless communications appliance 105 may be a cellular telephone, an android device, a tablet device, a laptop computer, or some other appliance having a processor, memory, and networking capability relative to the Internet network in this particular embodiment. In addition to collecting data from existing engine and power train sensors through ECU/PCM 106, wireless communications appliance 105 may also have connection to a variety of custom sensors deployed within vehicle 104 such as sensors 107 (1−n).

In a preferred embodiment, communications appliance 105 has wireless access to sensors 107 (1−n) and collects data from those sensors as well as from ECU/PCM 106.

The actual functions of each sensor may vary widely and may be custom selected and installed to provide specific types of data that might be useful in determining what needs the operator may have relative to a new vehicle type. Wireless communications device 105 may connect wireles sly to the Internet network through carrier network 102. A cellular relay tower 108 is illustrated and is exemplary of cell tower communication in a cellular network. A satellite 110 is illustrated as well and represents a satellite in a wireless satellite network. A service provider facility 109 is illustrated in this embodiment and represents a wireless Internet service provider. Facility 109 represents an Internet access point for wireless communications appliance 105.

Internet backbone 103 supports a server 111. Server 111 has a processor and a memory containing all of the instructions for functions as a network-connected server. Wireless communications device may establish a client/server connection with server 111 through wireless carrier network 102. In a preferred embodiment, data from ECU/PCM 106 and from sensors 107 (1−n) are collected by wireless communications appliance 105 with the aid of software (SW) 119. Data is collected primarily while vehicle 104 is being operated by the responsible driver. Data may be collected continuously or periodically using appliance 105. Appliance 105 may automatically upload a portion or all collected data to server 111 periodically or at pre-specified intervals. In one embodiment, data collection and server upload is fully automatic and transparent to the vehicle operator when the appliance is on and running SW 119.

In addition to data collected from vehicle 104, supplemental information may be provided to a service provider that is hosting server 111 through service registration or as result of a service request. Supplemental data may include operator profile data, some vehicle information not available through sensors, information about additional responsible drivers of vehicle 104, family information, recreational information, and work-related information (vehicle uses). Server 111 hosts SW 112. SW 112 is adapted to process data received from communications appliance 105 running SW 119 to produce a vehicle needs assessment that can be matched against vehicle data from a manufacturer or sales entity to obtain one or more than one recommendation of which vehicle type or types might best suit the needs of the owner/operator of vehicle 104.

Server 111 has connection to a data repository 114 adapted to contain client data and data collected and uploaded by clients. Client data may include many categories in addition to sensor data such as those described further above. Server 111 has connection to a data repository 113 containing business rules or constraints for processing client data at server 111. SW 111 functions to aid server 111 in processing of raw incoming data and may also, in one embodiment, serve notifications, alerts, advertisements, or promotional offers to clients relative to data analysis performed for those clients. In this example, network backbone 103 supports an advertisement server 115.

Advertisement server 115 contains a processor and a memory adapted to contain all of the software and instruction for enabling function as an advertisement server. Advertisement server 115 has connection to a data repository 116 containing promotional offers and other multimedia advertisements that can be sent or served to clients or potential vehicle consumers. Ad server 115 may be hosted by an auto sales entity. Ad server 115 might be hosted by a third-party and used by multiple vehicle sales teams or entities to deliver offers, recommendations, or the like. to clients based on an analysis of the client's needs.

In one embodiment, SW 112 running on server 111, notifies third party servers (applications) such as one (not illustrated) running on server 111 that certain vehicles and accessories that they offer were recommended to one or more clients. In this case, the sales entities may follow-up with advertising independently from server 111. In one embodiment, an ad server is used to prepare and server all advertisements resulting from a recommendation. In one embodiment, advertisers send their ads to server 111 and server 111 pushes the advertising to their clients. In this example, multiple vendors may compete for vehicle sales business by providing the technical data, feature data and optional accessory data that could match needs of clients.

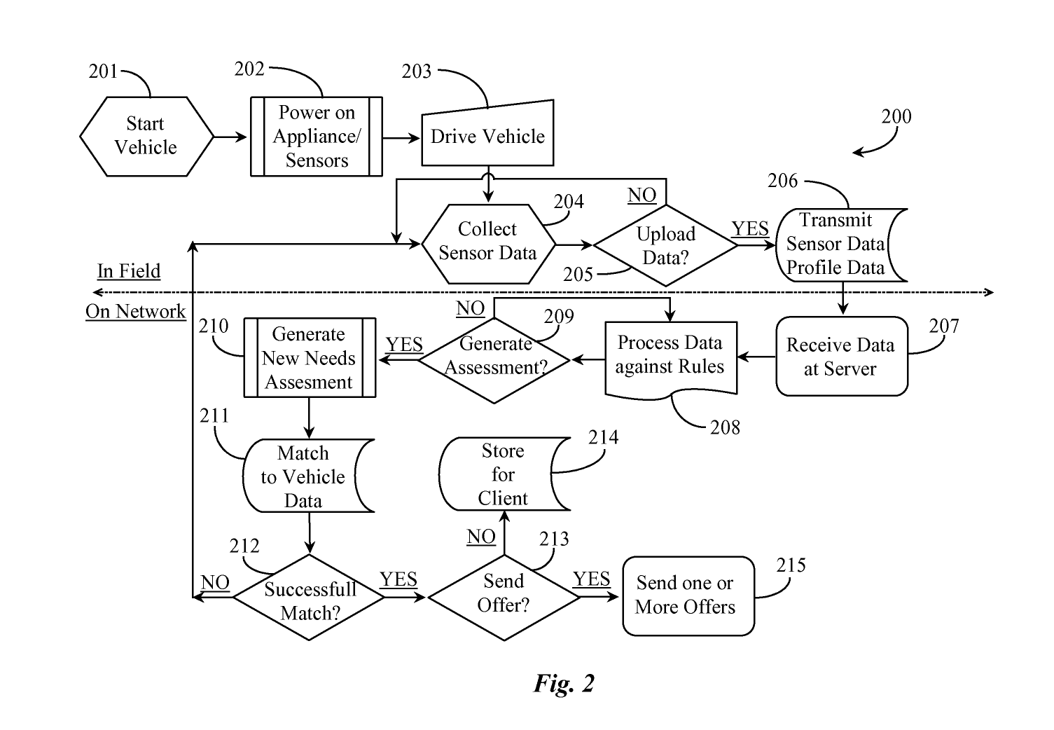

FIG. 2 is a process flow chart 200 depicting steps for generating a needs assessment from raw data and matching the assessment to one or more vehicle types. At step 201, a user practicing the invention starts a vehicle the user owns or is otherwise authorized to operate. At step 202, the wireless communication appliance and sensors power on. Powering on the communications device may be a manual step without departing from the spirit and scope of the invention. The wireless appliance may also be configured to automatically power up whenever the vehicle is turned on. Data may be collected automatically without intervention of the operator.

The operator drives the vehicle at step 203. The wireless communications appliance collects sensor data, including ECU/PCM data in step 204. Step 204 may be a continuous step while the vehicle ignition state is on. Data may be collected continuously or intermittently during a period of driving. A system rule might be in place to govern when data is uploaded from the wireless communications device to a server. At step 205, a decision (system) is made whether or not to upload data. For example, when data reaches a certain capacity threshold set for the wireless communications appliance, that data might automatically be uploaded. In one embodiment, an operator may manually upload the data from the wireless appliance.

If it is determined that no data will be uploaded at step 205, the process may resolve back to step 204 for continued data collection. If it is determined to upload data at step 205, then that data is transmitted from the wireless communications appliance to a network-connected server at step 206. Steps 201 through 206 are performed in the field where and at the time the vehicle is being operated. The amount of data collected and uploaded might vary widely depending on the length of vehicle operation and other factors.

The data sent from the field in step 206 is received at the server on the network in step 207. At step 208, the server with the aid of SW analogous to SW 112 of FIG. 1 processes the data against one or more rules or constraints. Processing may include data sorting and classification or categorization. In one embodiment, the process utilizes one or more algorithms to process data. In step 209, the system determines whether or not to generate a needs assessment based on the processed data. If the system determines not to generate a needs assessment, the process may resolve back to step 208 for further data processing.

The decision to generate a needs assessment after processing data may be based on one or more factors such as whether there is enough information to complete a needs assessment. In one embodiment, a needs assessment may be generated at some point in time after data was processed and stored for the client when it is determined or predicted that the client might be interested in a new vehicle. If it is determined at step 209 to generate a needs assessment, then a needs assessment is generated at step 210.

A needs assessment may be a summary of current needs the operator or owner of a participating vehicle has relative to a vehicle that might better suit the owner than the current vehicle the owner is driving. In a simplistic example of an assessed need, the owner might have a truck capable of towing 1000 pounds, but has repeatedly hauled a boat or trailer load of 1500 pounds, potentially damaging to the truck. That portion of the assessment summary might include a need of a vehicle having a tow package greater than 1500 pounds.

At step 211, the system attempts to match a needs assessment derived from raw collected data to a data and feature description of a new or used vehicle available for sale through a service organization or private seller. It is noted herein that the recommended vehicle does not have to be a new vehicle. In step 212 it is determined whether or not a successful match to at least one new vehicle description occurred. If no match is found, the process may resolve back to step 204 and loop back to step 212 after more data is collected and processed. A match may be attempted using a scoring mechanism and a percentage threshold. If a match is found at step 212 the system may decide whether or not to send an offer, notification, or other communication to the operator about the availability of one or more recommended vehicles at step 213.

If it is determined that an offer wont be sent at step 213, then the data and needs assessment may be stored for the client at step 214. If it is determined that an offer should be presented to the operator at step 213, then one or more offers may be sent to the operator/owner at step 215. In one embodiment, the server has access to vehicle data and feature description from manufacturers and sales organizations and may generate notifications, offers, advertisements, etc. and send those at will. In another embodiment, the system accesses the vehicle technical and feature data from servers of participating original equipment manufacturers (OEMs) or sales organizations that are local to the potential buyer (operator). It is also noted herein that there might be more than one vehicle recommended to the operator whose needs assessment matched the OEM and or sales vehicle data.

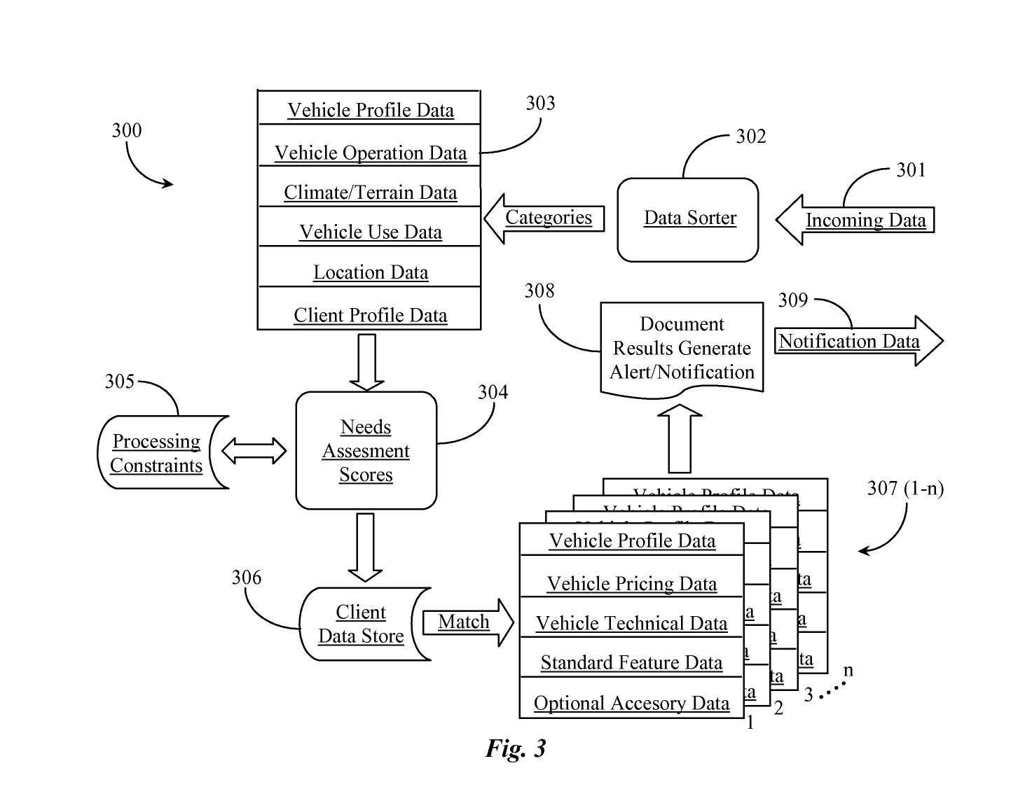

FIG. 3 is a block diagram 300 depicting basic server-processing tasks implemented before a vehicle type recommendation is made. Data collected from vehicle sensors and from ECU/PCM systems and uploaded to the server for processing via a wireless communications appliance is depicted herein as incoming data 301. Incoming data 301 may be raw unprocessed data or data having undergone minimal processing on the wireless appliance before transmission to the server. The server may employ a data sorter to sort the raw data into multiple categories of data represented herein as data categories 303.

Reading from top to bottom, data categories 303 include vehicle profile data, including make, model, year, and like information about the current vehicle owned. Vehicle operation data includes performance data, capacity data, mechanical condition, and like information relative to vehicle operation in the field (driving). Climate and terrain data includes information about the climate and terrain of the region the current vehicle is mostly operated. A vehicle might be operated mostly in a humid and damp climate or a dry and cold climate, etc. Terrain may indicate sea level measurements, roadway types, grades of slopes, etc. Climate and terrain data may be gathered from third-party sources based on information known such as the residence of the owner and location information available during driving of the vehicle. The location data may be global positioning satellite data available to the wireless appliance, the intermediate OBD device, or to a component on the vehicle such as the ECU/PCM.

Vehicle use data includes information about how the vehicle is used such as work use, recreational use, and so on. For example, a truck might be used principally as a farm vehicle whereas another truck of the same type might be used principally as a commuter vehicle. Location data includes documented locals where the vehicle has been driven including long and short trips that may be mapped out using continuous global positioning satellite (GPS) readings taken intermittently or periodically. Client profile data may include information about the owner or owners of the vehicle, authorized drivers of the vehicle, family information including pet information relative to passenger/transportation instances, and other profile data that might be deemed important such as owner “employed as a mechanic”. For a family, more than one family member having access to the vehicle might be profiled. Once the data is sorted and categorized, a needs assessment might be generated.

In one embodiment, each category in categories 303 has at least one to several sub-sets or categories of data that would logically fall under the broader category. Sub-categories could include, for example, mileage data under the category vehicle operation data, cargo weight data under the category vehicle profile data, etc. Many data values might be expressed as average values over time. In one embodiment, a scoring system might be used to determine individual scores for data item values that may result in that item being included in the needs assessment. Needs assessment scores 304 may be used to match against technical data and feature data including data about optional accessory packages that could be added to a new vehicle purchase. The server might access processing rules or constraints 305 while generating a needs assessment. In one embodiment, the processed data (needs assessment) along with actual raw data may be stored in a data store 306 on behalf of the client. The assessment may be retrieved at such time the system determines to attempt to match the assessment to vehicle data. This determination may depend on one or more factors. For example, if the client already purchased a new vehicle within a short time period in the past, it might not make sense to do any matching unless it is presumed the results might be significant enough to warrant trading in the current vehicle for a replacement vehicle.

In one embodiment, OEM or sale organization data, represented herein as several data sets 307 (1−n), includes data sorted into one or more categories. Each data set or summary 307 (1−n) represents data about one vehicle. The server may match data from the client data store to data sets 307 (1−n). The data sets might be retrieved from third-party services and categorized at the server in one embodiment. In this example, the categories include, reading from top to bottom, vehicle profile data, vehicle pricing data, vehicle technical data, standard feature data, and optional accessory data. In one embodiment, instead of notifying the operator of a new vehicle, the server may alert the operator about the assessed need and availability of some accessory like a vehicle winch, snow plow, trailer, vehicle cover, etc. In such a case products may be offered to potential buyers based on assessed need for those products. Matching results may be documented and an alert or notification might be generated by block 308. An alert or notification might vary widely according to the actual use case situation. Notification might be sent both to sales organizations (new/used vehicle lots) and owner operators in an attempt to bring them together to make an informed decision about future vehicle requirements for that client. The owner operator might get a promotional offer from one or more companies that are targeted to the products that matched the needs assessment above a specified percentage threshold. For example, Ford and Dodge might send an offer for a truck to a client of the service where the trucks both fulfill the needs assessment generated for the operator. Notification data sent back to the owner operator is represented herein as notification data 309.

The notification data may include advertisements, recommendation language, promotional offers including time sensitive discounts. The data may include messaging, email, video mail, brochures, pop-up advertisements, outbound telephony calls, mailed advertisements, voice over Internet protocol (VoIP) calls, etc. In one embodiment, after a needs assessment is created, a predictive algorithm might be executed at the server to gain a percentage of likelihood that the potential buyer will agree to an upgrade, a new accessory, or a new vehicle. There are many possibilities.

It will be apparent to one with skill in the art that the product recommendation system of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

What is claimed is:

1. An apparatus comprising:
at least one sensor for collecting data, the at least one sensor having connection to a first processor with a first memory, the first memory storing instructions that when executed by the processor cause the processor to:
record data associated with the act of driving a vehicle;
upload the recorded data to a service control point having a second processor with a second memory, the second memory storing instructions that when executed by the processor cause the processor to:
process the data received according to one or more pre-defined rules to develop a needs assessment relative to a new vehicle type;
match the needs assessment to existing feature data and technical data profiles generic to one or more new vehicle types; and
send at least one advertisement, notification, or promotional offer based on the match to the vehicle owner or owners.

2. The apparatus of claim 1 wherein the recorded data includes mileage data, vehicle operation data, cargo weight data, trip length data, location data, climate data, and profile information.

3. The apparatus of claim 1 wherein at least one sensor is a wireles sly operated sensor.

4. The apparatus of claim 1 wherein the first processor is integrated with or has access to a vehicle engine control module (ECM) and a power train control module (PCM) through an onboard diagnostic port (OBD).

5. The apparatus of claim 1 wherein the first processor is that of a hand-held computing appliance.

6. The apparatus of claim 2 wherein the location data is supplemented by global positioning satellite (GPS) data via a local GPS device accessible to the first processor.

7. The apparatus of claim 1 wherein the service control point (SCP) is a server connected to an Internet network.

8. The apparatus of claim 1 wherein the feature and technical data generic to new vehicle types are accessed from disparate servers hosted by disparate vehicle sales organizations competing for sales.

9. The apparatus of claim 8 wherein the at least one advertisement, notification, or promotional offer is accessed from at least one of the vehicle sales organizations.

10. The apparatus of claim 1 wherein the feature data includes optional accessories.

11. A method comprising the acts:
recording data associated with the act of driving a vehicle;
uploading the data to a service control point (SCP) for processing;
developing a needs assessment from the uploaded data;
matching the needs assessment to existing feature data and technical data profiles generic to one or more new vehicle types; and
sending at least one advertisement, notification, or promotional offer based on the match to the vehicle owner or owners.

12. The method of claim 11 wherein the recorded data includes mileage data, vehicle operation data, cargo weight data, trip length data, location data, climate data, and profile information.

13. The method of claim 12 wherein the location data is provided by global positioning satellite (GPS) via a local GPS device.

14. The method of claim 11 wherein the service control point (SCP) is a server connected to an Internet network.

15. The method of claim 11 wherein the feature and technical data generic to new vehicle types are accessed from disparate servers hosted by disparate vehicle sales organizations competing for sales.

16. The method of claim 11 further comprising:
initiating an authorization for a discount or a rebate upon positive response to any of the at least one advertisement, notification, or promotional offer.

17. The method of claim 11 wherein the feature and technical data generic to new vehicle types are accessed from disparate servers hosted by disparate vehicle sales organizations competing for sales.

18. The method of claim 11 wherein the at least one advertisement, notification, or promotional offer is sent from at least one of the vehicle sales organizations.

19. The method of claim 11 wherein the data is uploaded to the SCP periodically.

20. The method of claim 11 wherein the feature data includes optional accessories.
